(19) United States
(12) Patent Application Publication
(10) Pub. No.: US 2006/0125735 A1
(43) Pub. Date: Jun. 15, 2006

(54) Display device having a data driver integrated circuit with an improved transistor matching characteristic and a method of driving the same

(75) Inventor: Han-Su Pae, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/252,548

(22) Filed: Oct. 18, 2005

(30) Foreign Application Priority Data
Dec. 13, 2004 (KR) 2004-105019

(51) Int. Cl. G09G 3/30

(52) U.S. Cl. 345/76

(57) ABSTRACT

A display device having a data driver integrated circuit with an improved transistor matching characteristic and a method of driving the same are provided. The display device includes a pixel, a voltage generator generating and outputting a plurality of bias voltages, and a current source supplying a current to the pixel in response to one of the bias voltages corresponding to an image data signal.

### CROSS-REFERENCE TO RELATED APPLICATION

This U.S. non-provisional patent application claims priority under 35 U.S.C. § 119 to Korean Patent Application 2004-105019, filed on Dec. 13, 2004, the disclosure of which is incorporated by reference herein in its entirety.

### BACKGROUND

1. Technical Field

The present invention relates to display devices, and more particularly, to a current driven organic electroluminescence (OEL) display device and a method of driving the same.

2. Discussion of the Related Art

The luminescence of an organic compound was first observed in a single crystal of anthracene. Since then, industry has seized on this phenomenon by developing ultra-thin two-layer stacked OEL devices followed by the development of monochrome OEL display devices. More recently, small-sized OEL display devices have been developed.

An OEL display device is capable of being driven by an operating voltage which is lower than that used by other display devices such as thin-film-transistor liquid crystal displays (TFT-LCDs), plasma display panels (PDPs), field emission displays (FEDs), and so forth. The OEL display device is also self illuminable. Further, since the OEL display device does not use a backlight panel like a TFT-LCD, the OEL display device may be fabricated to be thinner than the TFT-LCD.

In comparison to a TFT-LCD device, the OEL display device operates with higher response speeds and has a wider visual angle. Accordingly, OEL display devices are increasingly being recognized as the next-generation in flat-panel display technology. For example, as OEL technology improves, OEL display devices are becoming adaptable for use with small-sized display apparatuses such as IMT2000 compatible devices, PDAs, and so forth. Thus, as the development of products using OEL display devices increases, such devices are expected to be competitive with the TFT-LCD devices in the markets of notebook computers and flat-panel televisions.

FIG. 1 illustrates the functional structure of a general OEL display device.

Referring to FIG. 1, the display device 10 includes a timing controller 100, a data driver integrated circuit (IC) 200, a voltage generator 300, a scan driver IC 400, and an OEL panel 500.

The timing controller 100 regulates and outputs image data signals in accordance with a timing pattern of the data driver IC 200 and the scan driver IC 400. The timing controller 100 also outputs control signals to regulate the data driver IC 200 and the scan driver IC 400.

The voltage generator 300 provides voltages that are used in the display device 10. For example, the voltage generator 300 outputs a power source voltage of 3.3V and a high voltage of 18V for activating the data driver IC 200.

The OEL panel 500 is used display a color image in response to image data signals, synch signals, and clock signals provided from a host (not shown). The OEL panel 500 includes a plurality of scan lines, data lines, which are arranged to intersect the scan lines, and pixels coupled to the scan and data lines. Each pixel of the OEL panel 500 contains an OEL cell.

The scan driver IC 400 outputs scan signals S0˜Sn for activating the scan lines in sequence (e.g., one at a time) in response to the control signals provided from the timing controller 100. Using this technique, all of the scan lines of the OEL panel 500 are activated in sequence.

The data driver IC 200 receives the image data signals from the timing controller 100, and then generates data-line drive signals corresponding to the image data signals to be transferred to the pixels of the OEL panel 500 via data lines D0˜Dn.

FIG. 2 shows the data driver IC 200 in more detail.

Referring to FIG. 2, the data driver IC 200 includes a reference current generator 210 and digital-analog converters (DACs) 220˜230.

The reference current generator 210 includes a PMOS transistor 211 having its source connected to a voltage VH and its drain connected to its gate and a current source 212. The DACs 220˜230 are serially connected to each other from the gate and drain of the PMOS transistor 211. A current output from the reference current generator 210 is provided to the DACs 220˜230 in a current mirror scheme.

The DACs 220˜230 are connected to the data lines D0˜Dn. As the circuit structure of the DACs 220˜230 is the same, the circuit structure of only one of the DACs 220˜230, DAC 220, will now be described.

As shown in FIG. 2, the DAC 220 includes PMOS transistors A0˜Ak-1, which act as current sources, and switches B0˜Bk-1. The sources of the PMOS transistors A0˜Ak-1 are commonly connected to the voltage VH, their drains are connected to the switches B0˜Bk-1, and their gates are commonly coupled to the reference current generator 210. The switches B0˜Bk-1 are controlled by corresponding bits of the image data signal provided from the timing controller 100. For example, the switches B0˜Bk-1 may be controlled by an image data signal DATA0[0:k-1] to drive the data line D0 and an image data signal DATAn[0:k-1] to drive the data line Dn.

As an example of the number of switches used by the DAC 220 for driving the data lines D0˜Dn, a binary-weighted 6-bit current DAC for driving a 256K-color OEL display panel uses 1, 2, 4, 8, 16, and 32-bit unit current-source transistors. In other words, 63-bit unit current-source transistors are used. In addition, 6 switching transistors are connected to each bit.

As another example, a segment-type 6-bit current DAC may be configured using a binary-type current DAC with a 3-bit LSB and a thermometer-type current DAC with a 3-bit MSB. In other words, the 3-bit LSB is configured into a circuit by using three transistors that are ¼, ½, and 1 times a unit transistor in size, and the 3-bit MSB is configured into a circuit by using seven current sources that are 2 times a unit transistor in size. Therefore, ten current-source transistors of four-types are used to form the segment-type 6-bit current DAC. In addition, three and seven switching transistors are used to form the 3-bit LSB and 3-bit MSB circuits, respectively.

The segment-type 6-bit DAC having the above described configuration is constructed with n-columns of the OEL panel 500 corresponding to the number of data lines D0˜Dn. For example, when a QVGA-level display device is constructed with 240 DACs, a data driver IC of the QVGA-level display device should be equipped with 240*63=15,120 current-source transistors (for binary-type) or 240*10=2400 current-source transistors (for segment-type) for the 6-bit digital-analog conversion.

Ideally the DACs 220˜230 generate the same current outputs from the same data signal inputs. However, there are typically errors among the output currents due to variations in processing profiles of the DACs 220˜230. In addition, the variation of a threshold voltage during a manufacturing process thereof in view of a constant bias voltage causes the fluctuation of an output current as quantified by the following Equation 1.
lout∝(Vbias−Vth)² [1]

Further, the bias voltage applied to the gate of the transistors A0˜Ak-1 should be higher than the threshold voltage of the transistors A0˜Ak-1 to minimize the variation of the output current against the variation of the threshold voltage. In this case, the variation of the threshold voltage is negligible because it is minute relative to the high bias voltage. In other words, a transistor forming the current source should be designed to be larger than ten times the minimum required transistor size. In addition, the channel width of the current-source transistor should be large so that it can be immune from variations resulting from processing conditions such as diffusion. The relation between the variation of an output current (e.g., Δ Iout) and transistor size is summarized by the following Equation 2.
Δ Iout ∝(W*L)^{1/2} [2]

To enhance the matching characteristic between output currents according to processing profiles of the DACs 220˜230, very large transistors should be employed. In addition, because each DAC 220˜230 may employ 63 transistors or 10 transistors of four-types, a uniform layout pattern for arranging the interconnections around the gates, source, and drains of their transistors for regulating the driving conditions of the transistors is needed. As such, a need exists for a data driving device capable of enhancing the matching characteristic between its output currents and that enables a uniform layout of transistors.

### SUMMARY OF THE INVENTION

The present invention is directed to a data driver IC, a display device having the data driver IC and a method of driving the same, wherein the data driver IC is capable of enhancing a matching characteristic between its output currents while using a amount of current-source transistors.

An aspect of the invention is a display device including: a pixel; a voltage generator outputting a plurality of bias voltages; and a current source supplying a current to the pixel in response to one of the bias voltages which corresponds to an image data signal.

In a preferred embodiment, the current source includes: a selector configured to select the bias voltage among the plurality of the bias voltages in correspondence with the image data signal; and a current supplier configured to supply the current, corresponding to the selected bias voltage, to the pixel.

In this embodiment, the current supplier includes a transistor with a current channel connected between a first voltage and the pixel, and a gate coupled to the selected bias voltage. The first voltage is higher than a power source voltage.

The image data signal is composed of k bits. The voltage generator is configured to generate 2^{k}−1 bias voltages, which are different from each other in voltage level. Here, the selector includes: a converter transforming the k-bit image data signal into a (2^{k}−1)-bit switching signal; and a plurality of switches connecting the bias voltage to the gate of the transistor in response to a corresponding bit of the switching signal, each switch corresponding to each bias voltage.

In this embodiment, the display device further includes a plurality of buffers arranged in correspondence with each of the plurality of the bias voltages, maintaining the bias voltages at predetermined levels.

Another aspect of the invention is a display device including: a plurality of pixels; a voltage generator outputting a plurality of bias voltages; and a plurality of current sources arranged in correspondence with the pixels, receiving a corresponding image data signal and selectively supplying currents to the pixels. Each current source supplies the current to a corresponding pixel in response to the bias voltage corresponding to the received image data signal.

In a preferred embodiment, each current source includes: a selector configured to select the bias voltage among the plurality of bias voltages in correspondence with the image data signal; and a current supplier configured to supply the current, corresponding to the selected bias voltage, to the corresponding pixel.

In this embodiment, the current supplier includes a transistor with a current channel connected between a first voltage and the pixel, and a gate coupled to the selected bias voltage.

In this embodiment, the first voltage is higher than a power source voltage.

The image data signal is composed of k bits, and the voltage generator is configured to generate 2^{k}−1 bias voltages, which are different from each other in voltage level. The selector includes: a converter transforming the k-bit image data signal into a (2^{k}−1)-bit switching signal; and a plurality of switches connecting the bias voltage to the gate of the transistor in response to a corresponding bit of the switching signal, each switch corresponding to each bias voltage.

In this embodiment, the display device further includes a plurality of buffers arranged in correspondence with each of the plurality of bias voltages, maintaining the bias voltages at predetermined levels.

Still another aspect of the invention is a display device including: a display panel including a plurality of scan lines, a plurality of data lines intersecting the scan lines, and a plurality of pixels coupled to each of the scan and data lines; a scan driver IC activating the scan lines in sequence; and a data driver IC providing image data signals to the pixels. The data driver IC is comprised of: a voltage generator outputting a plurality of bias voltages; and a plurality of current sources arranged in correspondence with the pixels, receiving a corresponding image data signal and selectively supplying currents to the pixels. Each current source supplies the current to corresponding pixels in response to the bias voltage corresponding to the received image data signal.

Yet another aspect of the invention is a method of driving a display device, including: generating a plurality of bias voltages; selecting a bias voltage corresponding to an image data signal; and supplying a current to a pixel in correspondence with the selected bias voltage.

In this embodiment, the image data signal is composed of k bits.

Generating the bias voltages includes: generating 2^{k}−1 bias voltages, which are different from each other in voltage level. Selecting the bias voltage includes: converting the k-bit image data signal into a (2^{k}−1)-bit switching signal; and selecting the bias voltage in response to a corresponding bit of the switching signal.

In this embodiment, the step of supplying the current to the pixel includes: converting the selected bias voltage into the current.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain the principles of the present invention. In the drawings:

FIG. 1 is a block diagram illustrating the functional structure of a general OEL display device;

FIG. 2 is a circuit diagram illustrating a conventional data driver IC;

FIG. 3 is a circuit diagram illustrating a data driver IC in accordance with a preferred embodiment of the invention; and

FIG. 4 is a flowchart showing an operating procedure of the data driver IC in accordance with a preferred embodiment of the invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the invention to those skilled in the art. Like numerals refer to like elements throughout the specification.

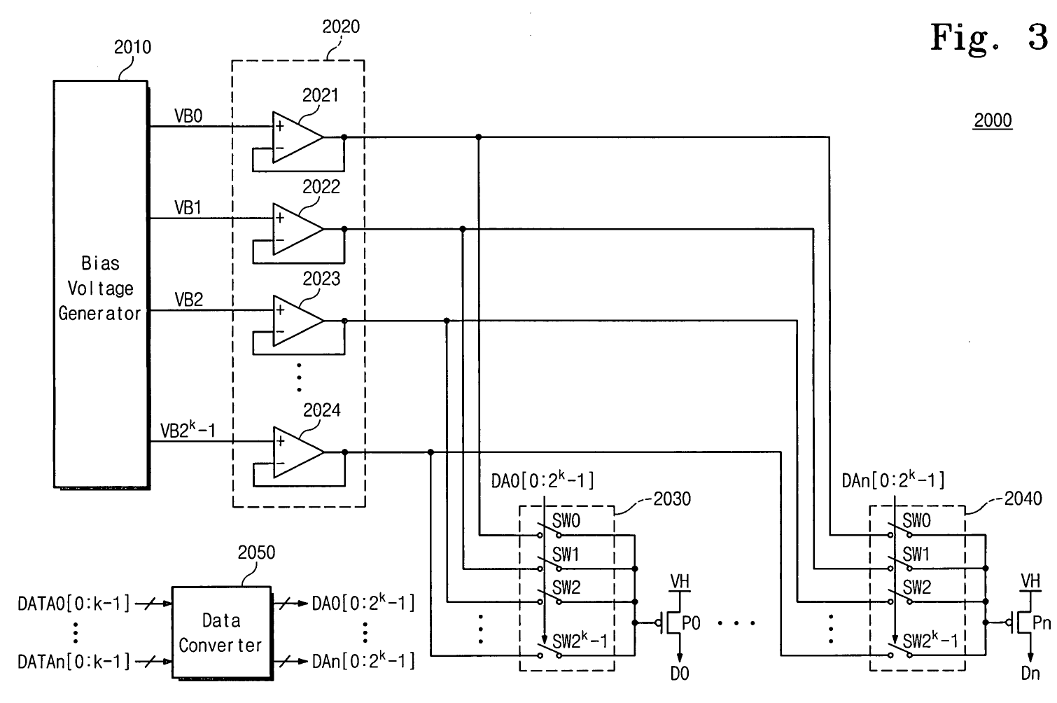

FIG. 3 is a circuit diagram illustrating a data driver IC 2000 in accordance with a preferred embodiment of the invention.

Referring to FIG. 3, the data driver IC 2000 includes a bias voltage generator 2010, a buffer 2020, switch arrays 2030˜2040, PMOS transistors P0˜Pn, and a data converter 2050.

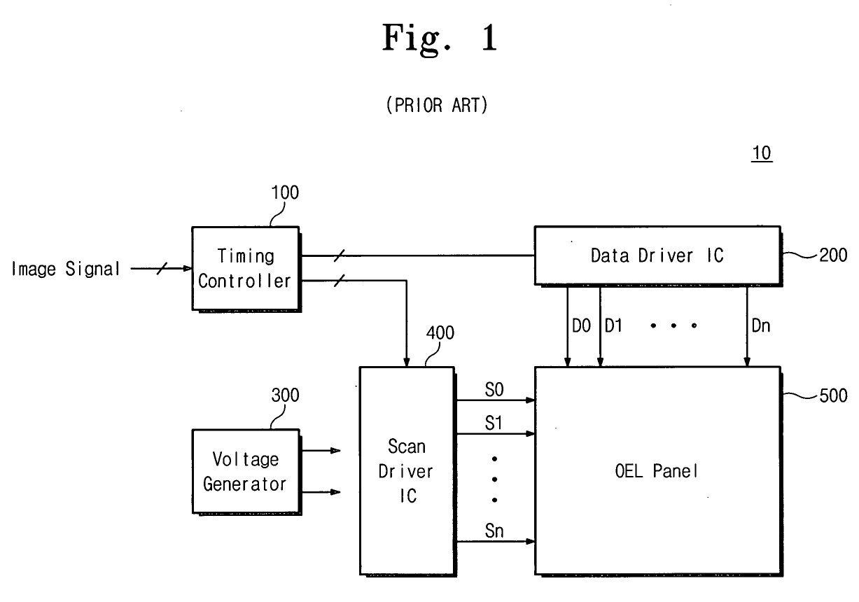

As shown in FIG. 3, the bias voltage generator 2010 is included in the data driver IC 2000. It may, however, be included in the voltage generator 300 shown in FIG. 1. In this case, the voltage generator 300 provides a plurality of bias voltages VB0˜VB²−1 to the data driver IC 2000. In addition, although the data converter 2050 is shown here in the data driver IC 2000, it may also be included in the timing controller 100 shown in FIG. 1.

Referring again to FIG. 3, the bias voltage generator 2010 outputs the plurality of bias voltages VB0˜VB2^{k}−1 and when an image data signal is composed of k bits, the bias voltage generator 2010 outputs 2^{k}−1 bias voltages having different voltage levels. For example, when the image data signal is composed of 6 bits, the bias voltage generator 2010 outputs 2⁶−1=63 bias voltages each having a different voltage level. It is to be understood by one of ordinary skill in the art that the bias voltages VB0˜VB₂^{k}−1 are lower than the voltage VH applied to the sources of the PMOS transistors P0˜Pn.

The buffer 2020 includes comparators 2021˜2024 each corresponding to the bias voltages VB0˜VB2^{k}−1. The buffer 2020 maintains the bias voltages VB0˜VB2^{k}−1 at stable voltage levels.

The switch arrays 2030˜2040 include 2^{k}−1 switches corresponding to the bias voltages VB0˜VB2^{k}−1. As the switch arrays 2030˜2040 have the same structure, the structure of only the switch array 2030 will now be described.

The switch array 2030 is composed of switches SW0˜SW2^{k}−1. The ends of the switches SW0˜SW2^{k}−1 are connected to corresponding bias voltages output from the buffer 2020, while the other ends of the switches SW0˜SW2^{k}−1 are connected to corresponding PMOS transistors P0˜Pn. The switches SW0˜SW2^{k}−1 are controlled by corresponding bits of data signals DA0˜DAn output from the data converter 2050.

As further shown in FIG. 3, the data converter 2050 transforms the k-bit data signals DATA0˜DATAn of, for example, the timing controller 100, into the data signals DA0˜DAn of 2^{k}−1 bits. The data signals DA0˜DAn are then provided as switching control signals to regulate the operation of the switches SW0˜SW2^{k}−1 of the switch array 2030.

The sources of the PMOS transistors P0˜Pn are commonly connected to the voltage VH, the drains are connected to the data lines D0˜Dn, and the gates are controlled by the bias voltage selected by the switch arrays 2030˜2040. In general, the voltage VH is higher than the power source voltage, which may be, e.g., 18V, supplied by the voltage generator 300. Thus, when the voltage VH is set to 18V, the bias voltages VB0˜VB2^{k}−1 supplied from the bias voltage generator 2010 are different than each other and lower than 18V.

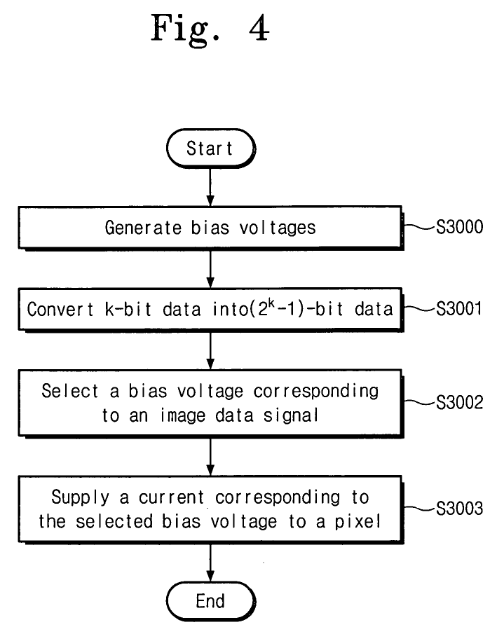

An operation of the data driver IC 2000 will now be described with reference to FIG. 4.

As shown in FIG. 4, in step S3000, the bias voltage generator 2010 generates and outputs the bias voltages VB0˜VB2^{k}−1.

In step S3001, the data converter 2050 transforms the k-bit image data signals DATA0˜DATAn, which are provided from the timing controller 100, into the (2^{k}−1)-bit image data signals DA0˜DAn.

In step S3002, the switches SW0˜SW2^{k}−1 of each of the switch arrays 2030˜2040 select their corresponding bias voltage in response to each of the image data signals DATA0˜DATAn.

In step S3003, the PMOS transistors P0˜Pn transfer the current, which corresponds to the selected bias voltage, to a corresponding pixel of, for example, the OEL panel 500 shown in FIG. 1, through one of the data lines D0˜Dn.

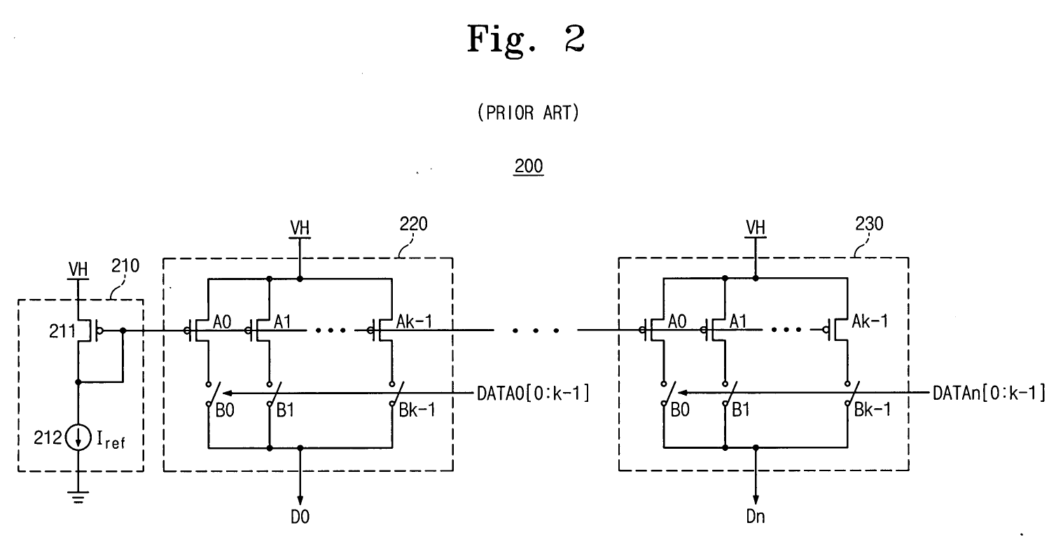

According to a preferred embodiment of the present invention, the data driver IC 2000 generates a current using a single current-source transistor connected to each of the data lines D0˜Dn after generating the plurality of bias voltages VB0˜VB2^{k}−1. Thus, when the data driver IC 2000 is employed in a QVGA display device it uses 240*3=720 current-source transistors. In comparison to the conventional data driver IC 200 of FIG. 2, which uses 240*63=15,120 current-source transistors (for binary-type) or 240*10=2400 current-source transistors (for segment-type) for 6-bit digital-analog conversion, the data driver IC 2000 uses only 720 transistors thereby enabling the size of a data driver IC 2000 chip to be reduced.

In addition, the data driver IC 2000 is capable of enhancing, for example, the impedance matching characteristic between its output currents without a significant increase in chip size as compared to that of the conventional data driver IC 200. For example, because data driver ICs are typically composed of large transistors to compensate for linear spots on a display panel resulting from variations in processing conditions, conventional data driver ICs that already have large amounts of transistors take up an even larger amount of space than the data driver IC of the present invention.

Although the present invention has been described in connection with the preferred embodiment of the present invention illustrated in the accompanying drawings, it is not to be limited thereto. It will be apparent to those skilled in the art that various substitutions, modifications and changes may be thereto without departing from the scope and spirit of the invention.

What is claimed is:

1. A display device comprising:
a pixel;
a voltage generator generating and outputting a plurality of bias voltages; and
a current source supplying a current to the pixel in response to one of the bias voltages corresponding to an image data signal.

2. The display device as set forth in claim 1, wherein the current source comprises:
a selector selecting the bias voltage from the plurality of bias voltages corresponding to the image data signal; and
a current supplier supplying the current corresponding to the selected bias voltage to the pixel.

3. The display device as set forth in claim 2, wherein the current supplier comprises a transistor with a current channel connected between a first voltage and the pixel, and a gate coupled to the selected bias voltage.

4. The display device as set forth in claim 3, wherein the first voltage is higher than a power source voltage.

5. The display device as set forth in claim 4, wherein the image data signal comprises k bits.

6. The display device as set forth in claim 5, wherein the voltage generator generates 2^{k}−1 bias voltages having different voltage levels.

7. The display device as set forth in claim 6, wherein the selector comprises:
a converter transforming the k-bit image data signal into a (2^{k}−1)-bit switching signal; and
a plurality of switches connecting the bias voltages to the gate of the transistor in response to a corresponding bit of the switching signal, wherein each switch corresponds to each bias voltage.

8. The display device as set forth in claim 7, further comprising:
a plurality of buffers arranged in correspondence with each of the plurality of the bias voltages, maintaining the bias voltages at predetermined levels.

9. The display device as set forth in claim 7, wherein the pixel is an organic electroluminescence pixel.

10. A display device comprising:
a plurality of pixels;
a voltage generator generating and outputting a plurality of bias voltages; and
a plurality of current sources arranged in correspondence with the pixels, receiving corresponding image data signals and selectively supplying currents to the pixels,
wherein each current source supplies the current to a corresponding pixel in response to the bias voltage corresponding to the received image data signal.

11. The display device as set forth in claim 10, wherein each of the current sources comprises:
a selector selecting the bias voltage from the plurality of the bias voltages corresponding to one of the image data signals; and
a current supplier supplying the current corresponding to the selected bias voltage to the corresponding pixel.

12. The display device as set forth in claim 11, wherein the current supplier comprises a transistor with a current channel connected between a first voltage and the pixel, and a gate coupled to the selected bias voltage.

13. The display device as set forth in claim 12, wherein the first voltage is higher than a power source voltage.

14. The display device as set forth in claim 12, wherein the image data signal comprises k bits.

15. The display device as set forth in claim 14, wherein the voltage generator generates 2^{k}−1 bias voltages having different voltage levels.

16. The display device as set forth in claim 15, wherein the selector comprises:
a converter transforming the k-bit image data signal into a (2^{k}−1)-bit switching signal; and
a plurality of switches connecting the bias voltages to the gate of the transistor in response to a corresponding bit of the switching signal, wherein each switch corresponds to each bias voltage.

17. The display device as set forth in claim 16, further comprising:
a plurality of buffers arranged in correspondence with each of the plurality of bias voltages, maintaining the bias voltages at predetermined levels.

18. The display device as set forth in claim 17, wherein the pixel is an organic electroluminescence pixel.

19. The display device as set forth in claim 10, wherein the voltage generator and the plurality of current sources form a data driver IC providing the image data signals to the pixels.

20. The display device as set forth in claim 19, further comprising:
a display panel including a plurality of scan lines, a plurality of data lines intersecting the scan lines, wherein the plurality of pixels are coupled to each of the scan and data lines; and
a scan driver IC activating the scan lines in sequence.

21. A method of driving a display device, comprising:
generating and outputting a plurality of bias voltages;
selecting a bias voltage from the plurality of bias voltages corresponding to an image data signal; and
supplying a current corresponding to the selected bias voltage to a pixel.

22. The method as set forth in claim 21, wherein the image data signal comprises k bits.

23. The method as set forth in claim 22, wherein generating and outputting the bias voltages comprises: generating 2^{k}−1 bias voltages having different voltage levels.

24. The method as set forth in claim 23, wherein selecting the bias voltage comprises:
converting the k-bit image data signal into a (2^{k}−1)-bit switching signal; and
selecting the bias voltage in response to a corresponding bit of the switching signal.

25. The method as set forth in claim 24, wherein supplying the current to the pixel comprises:
converting the selected bias voltage into the current.
